(19) United States
(12) Patent Application Publication
(10) Pub. No.: US 2020/0102922 A1
(43) Pub. Date: Apr. 2, 2020

(54) FUEL INJECTION VALVE

(71) Applicant: DENSO CORPORATION, Kariya-city (JP)

(72) Inventors: Hajime KATAOKA, Nisshin-city (JP); Noritsugu KATO, Kariya-city (JP)

(21) Appl. No.: 16/702,120

(22) Filed: Dec. 3, 2019

Related U.S. Application Data
(63) Continuation of application No. PCT/JP2018/019111, filed on May 17, 2018.

(30) Foreign Application Priority Data
Jun. 6, 2017 (JP) 2017-111780

(51) Int. Cl. F02M 61/18; F02M 61/04; F16K 51/00

(52) U.S. Cl. CPC F02M 61/18; F16K 51/00; F02M 61/042

(57) ABSTRACT

A needle has a seal portion that contacts a valve seat, and is provided so as to be able to reciprocate inside a valve body. A sack chamber is formed between the seal portion and a recess. A seal portion is formed in a curved shape protruding in the axial direction of the needle. A distance between an inlet intersection and a needle intersection on a same virtual straight line is defined as a distance Dh, and a distance between the recess and the seal portion on an axis of the valve body is defined as a distance Ds. When the seal portion is in contact with the valve seat, the distance Dh is larger than the distance Ds (Dh>Ds).

### CROSS REFERENCE TO RELATED APPLICATION

This application is a continuation application of International Patent Application No. PCT/JP2018/019111 filed on May 17, 2018, which designated the U.S. and based on and claims the benefits of priority of Japanese Patent Application No. 2017-111780 filed on Jun. 6, 2017. The entire disclosure of all of the above applications is incorporated herein by reference.

### TECHNICAL FIELD The present disclosure relates to a fuel injection valve.

### BACKGROUND

A fuel injection valve in which a volume of a sack chamber formed between a needle and a valve body and connected to an injection hole is reduced is known.

### SUMMARY

An aspect of the fuel injection valve according to the present disclosure includes a valve body and a needle.

The valve body has a fuel passage through which fuel flows, a valve seat formed on the inner wall forming the fuel passage, a concave portion recessed in the axial direction on the downstream side of the valve seat, and an injection hole connecting the concave portion and the outer wall.

The needle has a seal portion that is separated from the valve seat and come into contact with the valve seat. The needle is reciprocated inside the valve body, and the sack chamber is provided between the seal portion and the recess.

In the present disclosure, the seal portion is formed in a curved shape protruding in an axial direction of the needle. Therefore, the volume of the sack chamber can be reduced.

### BRIEF DESCRIPTION OF DRAWINGS

The above and other objects, features and advantages of the present disclosure will become more apparent from the following detailed description made with reference to the accompanying drawings. In the drawings:

FIG. 1 is a cross-sectional view showing a fuel injection valve according to a first embodiment;

FIG. 2 is a cross-sectional view showing an injection hole of the fuel injection valve and a vicinity thereof according to the first embodiment;

FIG. 3 is a diagram showing a relationship between a volume of a sack chamber and an amount of fuel wetting;

FIG. 4 is a cross-sectional view showing an injection hole of the fuel injection valve and a vicinity thereof according to the first embodiment, when the fuel injection valve is opened;

FIG. 5 is a cross-sectional view showing an injection hole and a vicinity thereof according to a comparative embodiment, when the fuel injection valve is opened;

FIG. 6 is a cross-sectional view showing an injection hole of the fuel injection valve and a vicinity thereof according to a second embodiment, when the fuel injection valve is opened; and

FIG. 7 is a cross-sectional view showing an injection hole of the fuel injection valve and a vicinity thereof according to a third embodiment, when the fuel injection valve is opened.

### DETAILED DESCRIPTION

Hereinafter, the fuel injection valves according to several embodiments are described with reference to the drawings. Components that are substantially the same in the plurality of embodiments are denoted by the same reference numerals and will not be described. Further, substantially identical elements in the embodiments achieve the same or similar effects.

### First Embodiment

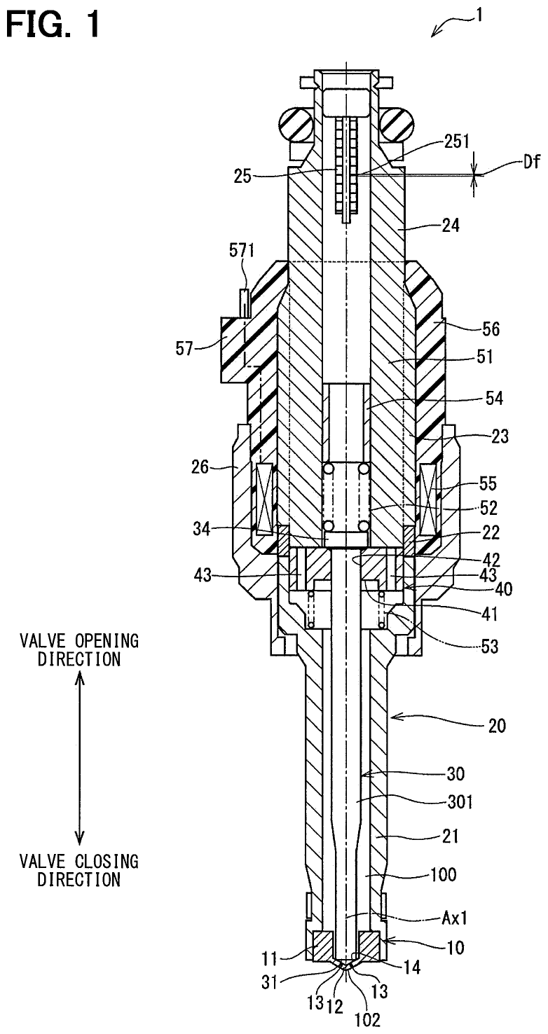

A fuel injection valve according to the first embodiment is shown in FIG. 1. The fuel injection valve 1 is applied to, for example, a gasoline engine as an internal combustion engine (hereinafter simply referred to as “engine”), and injects gasoline as fuel and supplies the fuel to the engine. The fuel injection valve 1 directly injects fuel into the combustion chamber of the engine. Thus, the fuel injection valve 1 is applied to a direct injection gasoline engine.

Next, a basic configuration of the fuel injection valve 1 will be described with reference to FIG. 1.

The fuel injection valve 1 includes a valve body 10, a housing 20, a filter 25 as a foreign material collecting portion, a needle 30, a movable core 40, a fixed core 51, a spring 52 as a valve seat side biasing member, a spring 53 as a fixed core side biasing member, a coil 55, and the like.

The valve body 10 is made of a metal such as martensitic stainless steel. The valve body 10 is quenched to have a predetermined hardness. As shown in FIG. 1, the valve body 10 includes a cylindrical portion 11, a bottom portion 12, an injection hole 13, a valve seat 14, and the like.

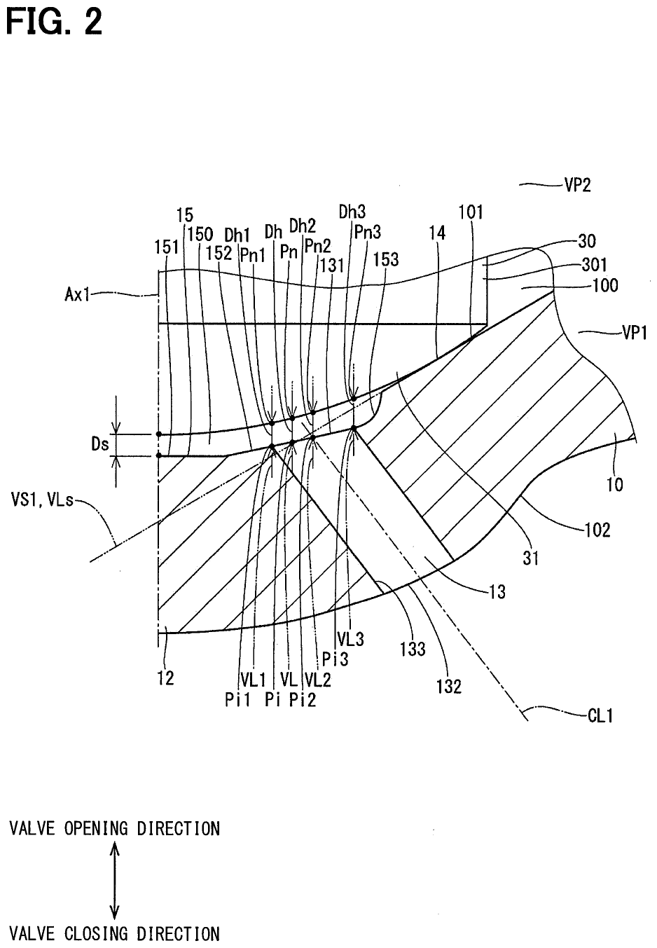

The cylindrical portion 11 is formed in a substantially cylindrical shape. The bottom portion 12 closes one end of the cylindrical portion 11. That is, the valve body 10 is formed in a bottomed cylindrical shape. The injection hole 13 is formed so as to connect a surface on the cylindrical portion 11 side of the bottom portion 12, that is, an inner wall 101 of the valve body 10, and a surface on an side opposite to the cylindrical portion 11, that is, an outer wall 102 of the valve body 10 (see FIG. 2). A plurality of injection holes 13 are formed in the bottom portion 12. In the present embodiment, for example, six injection holes 13 are formed at regular intervals in the circumferential direction in the bottom portion 12. The valve seat 14 is formed on the cylindrical portion 11 side of the bottom portion 12 on the inner wall 101 of the valve body 10, and in an annular shape around the outside of the injection hole 13. The configuration of the valve body 10 will be described in detail later.

The housing 20 includes a first cylinder part 21, a second cylinder part 22, a third cylinder part 23, an inlet part 24, and the like.

The first cylinder part 21, the second cylinder part 22, and the third cylinder part 23 are all formed in a substantially cylindrical shape. The first cylinder part 21, the second cylinder part 22, and the third cylinder part 23 are arrange so that it becomes coaxial in order of the first cylinder part 21, the second cylinder part 22, and the third cylinder part 23, and are mutually connected.

The first cylinder part 21 and the third cylinder part 23 are formed, for example, of a magnetic material, such as ferritic stainless steel, and are subjected to a magnetic stabilization process. The second cylinder part 22 is formed of a nonmagnetic material such as austenitic stainless steel and the like.

The second cylinder part 22 functions as a magnetoresistance part. The first cylinder part 21 is provided so that the inner wall at the end opposite to the second cylinder part 22 is fitted to the outer peripheral wall of the cylindrical portion 11 of the valve body 10.

The fixed core 51 is formed in a substantially cylindrical shape of a magnetic material such as ferritic stainless steel, like the third cylinder part 23. The fixed core 51 is subjected to a magnetic stabilization process. The fixed core 51 is formed integrally with the third cylinder part 23 so that the outer peripheral wall of the fixed core 51 is joined to the inner peripheral wall of the third cylinder part 23.

The inlet part 24 is formed in a cylindrical shape of a magnetic material such as ferritic stainless steel, like the fixed core 51. The inlet part 24 is formed integrally with the fixed core 51 so that one end of the inlet part 24 is connected to the end of the fixed core 51 on the side opposite to the valve body 10. Thus, in the present embodiment, the third cylinder part 23, the fixed core 51, and the inlet part 24 are integrally formed of the same material. An inner diameter of the fixed core 51 and an inner diameter of the inlet part 24 are set to be the same.

A fuel passage 100 is formed inside the inlet part 24, inside the fixed core 51, inside the second cylinder part 22, inside the first cylinder part 21, and inside the valve body 10. That is, the inner wall 101 of the valve body 10 forms a part of the fuel passage 100.

The fuel passage 100 connects an end opening of the inlet part 24 on the side opposite to the fixed core 51 and the injection hole 13. A pipe (not shown) is connected to the end of the inlet part 24 on the side opposite to the fixed core 51. As a result, fuel from a fuel supply source (not shown), such as fuel pump flows into the fuel passage 100 via the pipe. The fuel passage 100 introduces fuel to the injection hole 13.

The filter 25 is formed in a bottomed cylindrical shape, for example. The filter 25 is provided inside the end of the inlet part 24 on the side opposite to the fixed core 51 so that the bottom faces toward the valve body 10 (see FIG. 1). The filter 25 has a plurality of holes 251. The plurality of the holes 251 connect an inner side and an outer side of the filter 25. Therefore, the fuel can pass through the holes 251. Here, foreign materials in the fuel that are larger than a maximum width of the holes 251 cannot pass through the holes 251. That is, the filter 25 can collect foreign materials larger than the maximum width of the holes 251 among the foreign materials in the fuel flowing through the fuel passage 100 from the pipe side to the injection hole 13 side. Thereby, it is possible to suppress foreign materials larger than the maximum width of the holes 251 from flowing to the injection hole 13 side of the fuel passage 100.

The needle 30 is formed in a rod shape of a metal such as martensitic stainless steel and the like. The needle 30 is quenched so as to have a predetermined hardness.

The needle 30 is provided inside the housing 20 so as to reciprocate in the fuel passage 100 in the axial direction of the housing 20. The needle 30 has a needle body 301, a seal portion 31, a flange portion 34, and the like.

The needle body 301 is formed in a rod shape.

The seal portion 31 is formed integrally with one end of the needle body 301, that is, the needle body 301 at the end on the valve body 10 side. The seal portion 31 can contact the valve seat 14. That is, the needle 30 is provided so as to be able to reciprocate inside the valve body 10 so that the seal portion 31 can be separated from the valve seat 14 and abutted against the valve seat 14.

The flange portion 34 is formed in a substantially cylindrical shape so as to extend radially outward from the other end of the needle body 301, that is, the end on the side opposite to the seal portion 31. The flange portion 34 is formed integrally with the needle body 301. The flange portion 34 is formed so as to be located inside the end of the fixed core 51 on the valve body 10 side when the seal portion 31 is in contact with the valve seat 14. In this situation, a surface of the flange portion 34 on the valve body 10 side is located closer to the valve body 10 side than the end surface of the fixed core 51 on the valve body 10 side. Further, an outer diameter of the flange portion 34 is smaller than an inner diameter of the fixed core 51. Therefore, the fuel can flow in the gap between an outer peripheral wall of the flange portion 34 and an inner peripheral wall of the fixed core 51 in the fuel passage 100.

The needle 30 opens and closes the injection hole 13 when the seal portion 31 is separated (away) from the valve seat 14 or abuts (sits) the valve seat 14. Hereinafter, the direction in which the needle 30 is separated from the valve seat 14 is referred to as valve opening direction, and the direction in which the needle 30 contacts the valve seat 14 is referred to as valve closing direction.

A movable core 40 is made of a magnetic material such as ferritic stainless steel and the like. The movable core 40 is subjected to a magnetic stabilization process. The movable core 40 is provided inside a connection portion between the first cylinder part 21 and the second cylinder part 22 of the housing 20.

The movable core 40 is formed in a substantially cylindrical shape. The movable core 40 is formed with a recess 41, a shaft hole 42, and a through hole 43.

The recess 41 is formed so as to be recessed on the side opposite to the valve body 10 from a center of an end face of the movable core 40 on the valve body 10 side. The shaft hole 42 is formed so as to connect an end surface of the movable core 40 on the side opposite to the valve body 10 and a bottom surface of the recess 41 through the axis of the movable core 40. The through hole 43 is formed so as to connect the end surface of the movable core 40 on the valve body 10 side and the end surface of the movable core 40 on the side opposite to the valve body 10. A plurality of through holes 43 are formed at equal intervals in the circumferential direction of the movable core 40 on the radially outer side of the recess 41.

The movable core 40 is provided inside the housing 20 in a state where the needle body 301 is inserted in the shaft hole 42. That is, the movable core 40 is provided outside the needle body 301 in the radial direction. The movable core 40 is relatively movable in the axial direction with respect to the needle body 301 on the valve body 10 side of the flange portion 34. The inner wall forming the shaft hole 42 of the movable core 40 is slidable with the outer peripheral wall of the needle body 301. Further, the outer peripheral wall of the movable core 40 is slidable with the inner peripheral walls of the first cylinder part 21 and the second cylinder part 22 of the housing 20. Thereby, the movable core 40 and the needle 30 are guided to move forward and backward in the axial direction inside the housing 20.

In the movable core 40, a portion around the shaft hole 42 in the surface on the side opposite to the valve body 10 abuts on the surface of the flange portion 34 on the valve body 10 side, or is separated from a surface of the flange portion 34 on the valve body 10 side. When the surface of the movable core 40 on the side opposite to the valve body 10 is in contact with the fixed core 51 and the flange portion 34, the seal portion 31 of the needle 30 is separated from the valve seat 14, that is, the valve is opened.

A cylindrical adjusting pipe 54 is press-fitted inside the fixed core 51.

A spring 52 is, for example, a coil spring, and is provided inside the fixed core 51 and between the adjusting pipe 54 and the needle 30. One end of the spring 52 is in contact with the adjusting pipe 54. The other end of the spring 52 is in contact with the end surface of the flange portion 34 or the end surface of the needle body 301 on the side opposite to the valve body 10. The spring 52 can urge the movable core 40 together with the needle 30 toward the valve body 10, that is, in the valve closing direction. The biasing force of the spring 52 is adjusted by a position of the adjusting pipe 54 with respect to the fixed core 51.

The coil 55 is formed in a substantially cylindrical shape, and is provided so as to surround the outer side in the radial direction of the connection portion between the second cylinder part 22 and the third cylinder part 23 in the housing 20. A cylindrical holder 26 is provided outside the coil 55 in the radial direction so as to cover the coil 55. The holder 26 is made of a magnetic material such as ferritic stainless steel and the like. The holder 26 has one end of the inner peripheral wall connected to the outer peripheral wall of the first cylinder part 21 and the other end of the inner peripheral wall magnetically connected to the outer peripheral wall of the third cylinder part 23.

The coil 55 generates a magnetic force when electric power is supplied (energized). When a magnetic force is generated in the coil 55, a magnetic circuit is formed through the movable core 40, the first cylinder part 21, the holder 26, the third cylinder part 23, and the fixed core 51, avoiding the second cylinder part 22 as the magnetoresistance part. Thereby, a magnetic attraction force is generated between the fixed core 51 and the movable core 40, and the movable core 40 is attracted to the fixed core 51 side together with the needle 30. As a result, the needle 30 moves in the valve opening direction, and the seal portion 31 is separated from the valve seat 14 and the valve is opened. As a result, the injection holes 13 are opened. Thus, when the coil 55 is energized, it is possible to attract the movable core 40 toward the fixed core 51 and move the needle 30 to the side opposite to the valve seat 14.

When the movable core 40 is attracted to the fixed core 51 side (the valve opening direction) by the magnetic attraction force, the flange portion 34 of the needle 30 moves in the axial direction inside the fixed core 51. At this time, the outer peripheral wall of the flange portion 34 and the inner peripheral wall of the fixed core 51 do not slide each other.

A substantially cylindrical gap is always formed between the outer peripheral wall of the flange portion 34 and the inner peripheral wall of the fixed core 51. Therefore, when the fixed core 51 and the movable core 40 are not in contact with each other, the fuel on the inlet part 24 side with respect to the flange portion 34 passes through the substantially cylindrical gap, between the fixed core 51 and the movable core 40, and the through hole 43, and flows to the valve body 10 side with respect to the movable core 40.

Further, when the movable core 40 is attracted toward the fixed core 51 (in a valve opening direction) by the magnetic attraction force, the end surface on the fixed core 51 side collides with the end surface of the fixed core 51 on the movable core 40 side. Thereby, the movement of the movable core 40 in the valve opening direction is restricted.

When the energization to the coil 55 is stopped in a state where the movable core 40 is attracted to the fixed core 51 side, the needle 30 and the movable core 40 are urged toward the valve seat 14 by the urging force of the spring 52. As a result, the needle 30 moves in the valve closing direction, the seal portion 31 comes into contact with the valve seat 14 and the valve is closed. As a result, the injection holes 13 are closed.

A spring 53 is, for example, a coil spring, and is provided between the movable core 40 and the housing 20. One end of the spring 53 abuts between the recess 41 and the through hole 43 on the end surface of the movable core 40 on the valve body 10 side, and the other end of the spring 53 abuts a step surface on the inner wall of the first cylinder part 21 of the housing 20. The spring 53 can bias the movable core 40 toward the fixed core 51, that is, in the valve opening direction. The biasing force of the spring 53 is smaller than the biasing force of the spring 52. Therefore, when the coil 55 is not energized, the seal portion 31 of the needle 30 is pressed against the valve seat 14 by the spring 52, and the movable core 40 is pressed against the flange portion 34 by the spring 53.

As shown in FIG. 1, the radially outer side of the third cylinder part 23 is molded by a molding portion 56 made of resin. A connector portion 57 is formed so as to protrude radially outward from the molding portion 56. In the connector portion 57, a terminal 571 is insert-molded so as to supply electric power to the coil 55.

The fuel that has flowed into the inlet part 24 from the pipe is introduced to the injection holes 13 through the filter 25, inside of the fixed core 51 and the adjusting pipe 54, the gap between the flange portion 34 and the fixed core 51, and between the fixed core 51 and the movable core 40, the through hole 43, between the needle 30 and the inner wall of the housing 20, between the needle 30 and the inner wall 101 of the valve body 10, that is, through the fuel passage 100. When the fuel injection valve 1 is operated, the periphery of the movable core 40 and the needle 30 is filled with fuel. Further, when the fuel injection valve 1 is operated, the fuel flows through the through hole 43 of the movable core 40. Therefore, the movable core 40 and the needle 30 can smoothly move forward and backward in the axial direction inside the housing 20.

The pressure of the fuel in the fuel passage 100 assumed when the fuel injection valve 1 of the present embodiment is used is, for example, about 1 to 100 MPa.

Next, the configuration of the valve body 10 of the present embodiment will be described in detail based on FIG. 2. FIG. 2 shows a state where the needle 30 is in contact with the valve seat 14 and the valve is closed.

As shown in FIG. 2, the valve body 10 includes a recess 15, an inlet opening 131, an outlet opening 132, an injection hole inner wall 133, the injection hole 13, and the valve seat 14.

The recess 15 is formed so as to be recessed in a circular shape on the opposite side with respect to the needle 30 from the inner portion of the valve seat 14 on the surface of the bottom portion 12 on the cylindrical portion 11 side. In the recess 15, a flat portion 151, a tapered portion 152, and a curved surface portion 153 are formed.

The flat portion 151 is formed in a circular flat shape at the center of the bottom surface of the recess 15. The flat portion 151 is formed so that an axis Ax1 of the valve body 10 passes through the center of the flat portion 151 and so as to be substantially orthogonal to the axis Ax1. The tapered portion 152 is formed in an annular shape so as to continue to a radially outer side of the flat portion 151. The tapered portion 152 is formed in a tapered shape so as to be separated from the axis Ax1 of the valve body 10 as it goes from the flat portion 151 toward the valve opening direction. The curved surface portion 153 is formed in a curved surface shape so as to connect the tapered portion 152 and the valve seat 14.

In the present embodiment, an inlet opening 131 is formed in the tapered portion 152. An outlet opening 132 is formed in the outer wall 102 which is the surface of the bottom portion 12 on the side opposite to the cylindrical portion 11. The outer wall 102 is formed in a curved surface so as to protrude in the axial direction of the valve body 10.

An injection hole inner wall 133 connects the inlet opening 131 and the outlet opening 132. The injection hole 13 is formed by the injection hole inner wall 133, and the fuel flowing in from the inlet opening 131 injects from the outlet opening 132.

The valve seat 14 is formed in a tapered shape so as to approach the axis Ax1 of the valve body 10 as it goes in the valve closing direction.

In the present embodiment, the injection hole 13 is formed so that a injection hole center line CL1 that is the center line of the injection hole 13 intersects the axis Ax1 of the valve body 10.

In the present embodiment, the injection hole inner wall 133 is formed in a substantially cylindrical shape. That is, the injection hole inner wall 133 is formed so that a cross-sectional shape along a plane perpendicular to the injection hole center line CL1 is circular. Therefore, the injection hole inner wall 133 is formed in a straight shape having the same inner diameter from the inlet opening 131 side to the outlet opening 132 side.

Moreover, in the present embodiment, a virtual surface VS1 which extends the valve seat 14 to the recess 15 side crosses the injection hole inner wall 133 which is an inner wall of the injection hole 13 (see FIG. 2). That is, in the cross section along a virtual plane VP1 including the axis Ax1 of the valve body 10, a virtual straight line VLs extending along the valve seat 14 passes through a portion on the axis Ax1 side in the injection hole inner wall 133. Therefore, when the seal portion 31 is separated from the valve seat 14, the fuel flowing toward the injection hole 13 along the valve seat 14 collides with a portion on the axis Ax1 side of the injection hole inner wall 133 via the inlet opening 131, and flows to the outlet opening 132 side along the injection hole inner wall 133.

In the present embodiment, the seal portion 31 is formed in a curved shape protruding in the axial direction of the needle 30. More specifically, the seal portion 31 is formed in a spherical shape protruding in the axial direction of the needle 30. That is, the seal portion 31 has an SR (Sphere Radius) shape and coincides with a part of an imaginary spherical surface centered on a point on the axis of the needle 30. Therefore, in the cross section along a virtual plane VP2 including the axis of the needle 30, a curvature of the wall surface of the seal portion 31 is constant in the radial direction of the needle 30.

In the seal portion 31, an annular portion in the vicinity of the outer edge portion can contact the valve seat 14. When the seal portion 31 is in contact with the valve seat 14, that is, when the valve is closed, the fuel on an upstream side of the valve seat 14 is restricted from flowing to a downstream side of the valve seat 14. At this time, a sack chamber 150 is formed between the seal portion 31, the recess 15, and an inner edge portion of the valve seat 14. More specifically, the sack chamber 150 is a space surrounded by the seal portion 31, the recess 15, and the inner edge portion of the valve seat 14 inside the annular contact portion between the valve seat 14 and the seal portion 31. In the present embodiment, the volume of the sack chamber 150 is set to be smaller than 0.06 mm³ (cubic millimeter), for example.

Hereinafter, even when the seal portion 31 is separated from the valve seat 14, that is, when the valve is opened, a space corresponding to the sack chamber 150 formed when the valve is closed may be referred to as a sack chamber 150.

As shown in FIG. 2, in the present embodiment, a straight line extending through the inlet opening 131 that is the opening of the injection hole 13 in the recess 15 and parallel to the axis Ax1 of the valve body 10 is defined as a virtual straight line VL, an intersection of the virtual straight line VL and the inlet opening 131 is defined as an inlet intersection Pi, an intersection of the virtual straight line VL and the seal portion 31 is defined as a needle intersection Pn, a distance between the inlet intersection Pi and the needle intersection Pn on the same virtual straight line VL is defined as a distance Dh, and a distance between the recess 15 and the seal portion 31 on the axis Ax1 of the valve body 10 is defined as a distance Ds. When the seal portion 31 is in contact with the valve seat 14, the distance Dh is larger than the distance Ds (Dh>Ds).

More specifically, a straight line extending through the portion closest to the axis Ax1 in the inlet opening 131 and extending in parallel with the axis Ax1 of the valve body 10 is defined as a virtual straight line VL1, an intersection of the virtual straight line VL1 and the inlet opening 131 is defined as an inlet intersection Pi1, an intersection of the virtual straight line VL and the seal portion 31 is defined as a needle intersection Pn1, a distance between the inlet intersection Pi1 and the needle intersection Pn1 on the same virtual straight line VL is defined as a distance Dh1. When the seal portion 31 is in contact with the valve seat 14, the distance Dh1 is larger than the distance Ds (Dh1>Ds).

Furthermore, a straight line extending through an intersection of the inlet opening 131 and the injection hole center line CL1 and extending in parallel with the axis Ax1 of the valve body 10 is defined as a virtual straight line VL2, an intersection of the virtual straight line VL2 and the inlet opening 131 is defined as an inlet intersection Pi2, an intersection of the virtual straight line VL2 and the seal portion 31 is defined as a needle intersection Pn2, a distance between the inlet intersection Pi2 and the needle intersection Pn2 on the same virtual straight line VL2 is defined as a distance Dh2. When the seal portion 31 is in contact with the valve seat 14, the distance Dh2 is larger than the distance Ds (Dh2>Ds).

Furthermore, a straight line extending through the portion farthest to the axis Ax1 in the inlet opening 131 and extending in parallel with the axis Ax1 of the valve body 10 is defined as a virtual straight line VL3, an intersection of the virtual straight line VL3 and the inlet opening 131 is defined as an inlet intersection Pi3, an intersection of the virtual straight line VL and the seal portion 31 is defined as a needle intersection Pn3, a distance between the inlet intersection Pi3 and the needle intersection Pn3 on the same virtual straight line VL3 is defined as a distance Dh3. When the seal portion 31 is in contact with the valve seat 14, the distance Dh3 is larger than the distance Ds (Dh3>Ds).

In the present embodiment, the distance Dh3 is larger than the distance Dh2, and the distance Dh2 is larger than the distance Dh1 (Dh3>Dh2>Dh1).

In the present embodiment, the distance Ds is larger than the distance Df (Ds>Df). Here, the distance Df is the maximum width of the hole 251 of the filter 25.

Next, the effect of the fuel injection valve 1 of the present embodiment will be described.

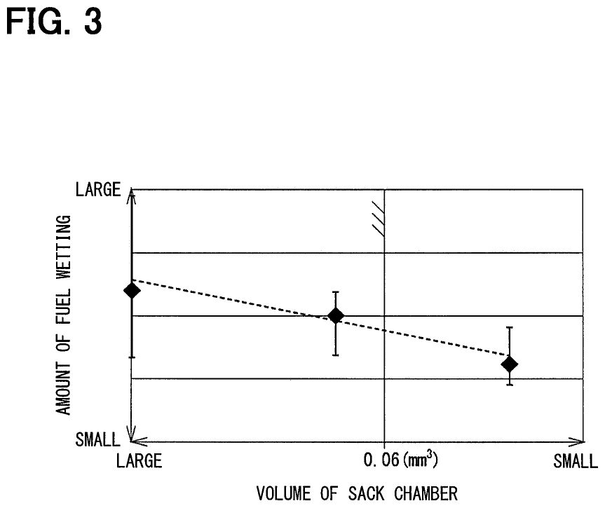

FIG. 3 is a diagram showing a relationship between a volume of the sack chamber 150 and an amount of fuel wetting; Here, the “amount of fuel wetting” is the amount of fuel in which the residual fuel in the sack chamber 150 leaks from the injection hole 13 and adheres to the outer wall 102 of the valve body 10 after the needle 30 is closed. When the amount of fuel wetting is large, the amount of particulate material such as soot may increase. FIG. 3 shows that the amount of fuel wetting becomes smaller when the volume of the sack chamber 150 becomes smaller. As described above, in the present embodiment, the volume of the sack chamber 150 is set to be smaller than 0.06 mm³ (cubic millimeter). Therefore, the amount of fuel wetting can be reduced, and the amount of particulate material such as soot can be reduced.

Further, as described above, in the present embodiment, since the maximum width of the hole 251 of the filter 25 is set to the distance Df, it is possible to prevent foreign materials having a size larger than the distance Df from flowing into the sack chamber 150. Further, since the distance Ds is larger than the distance Df (Ds>Df), it is possible to prevent foreign material from being sandwiched between the seal portion 31 and the recess 15 of the needle 30.

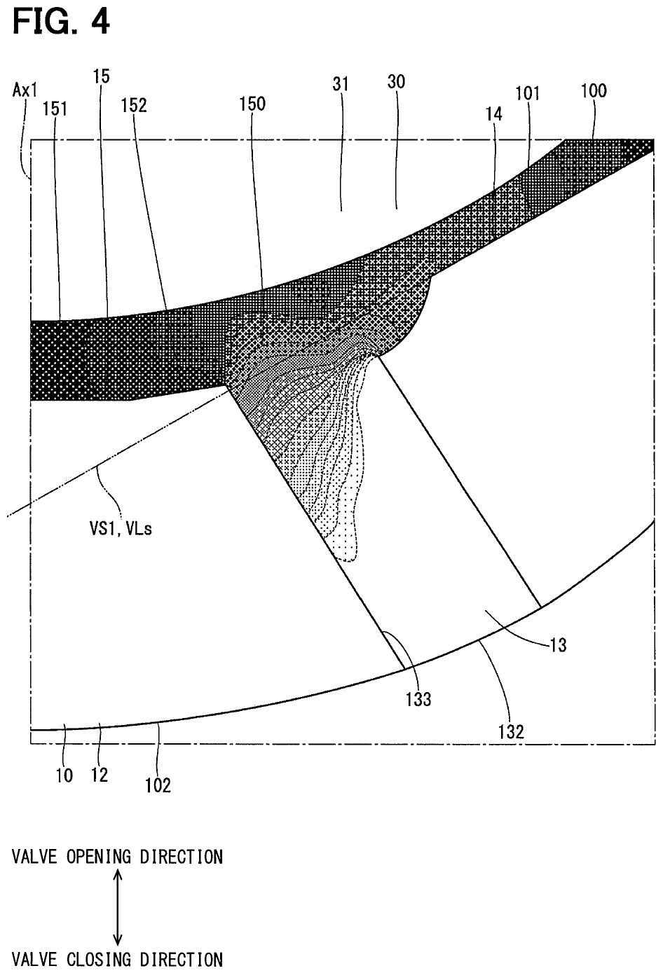

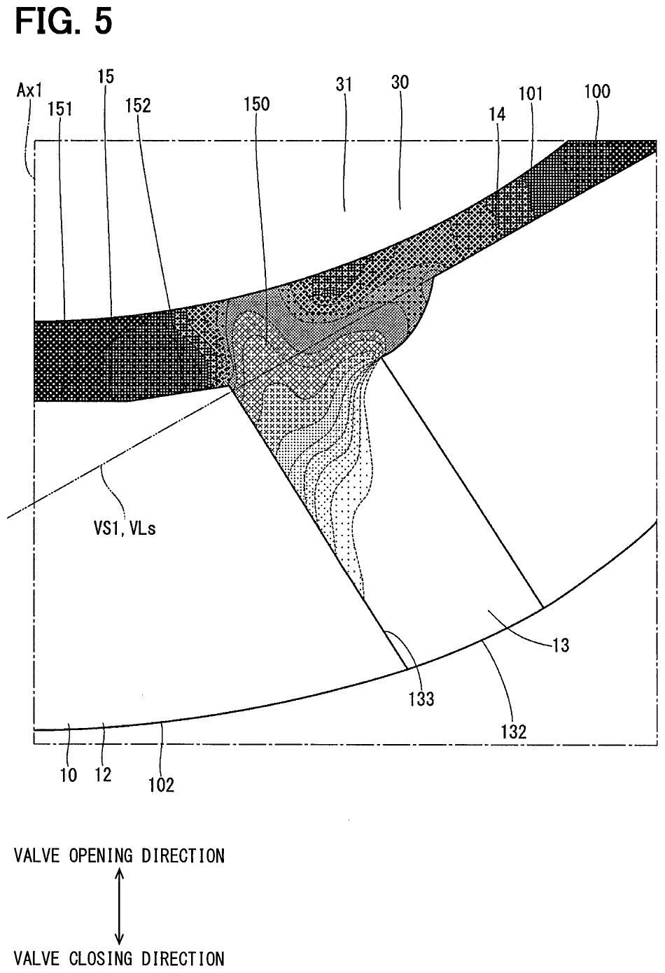

FIG. 4 is a cross-sectional view of the injection hole 13 and a vicinity thereof when the fuel injection valve 1 according to the present embodiment is opened. FIG. 5 is a cross-sectional view showing an injection hole 13 and a vicinity thereof when the fuel injection valve according to a comparative embodiment is opened. Here, although the physical configuration of the fuel injection valve according to the comparative embodiment is substantially the same as that of the present embodiment, in the comparative embodiment the distance Dh is smaller than the distance Ds (Dh<Ds) when the seal portion 31 is in contact with the valve seat 14.

In FIGS. 4 and 5, hatching of the cross section of members is omitted in order to avoid complication of the drawing. In the figures, when the shaded area becomes darker, the pressure becomes higher. As shown in FIG. 4, in the present embodiment, that the pressure between the valve seat 14 and the injection hole 13, that is, on the upstream side of the injection hole 13 is generally high and uniform when the valve is opened. That is, in the present embodiment, the pressure loss of the fuel passing through the valve seat 14 and flowing along the seal portion 31 and flowing into the injection hole 13 can be suppressed.

On the other hand, as shown in FIG. 5, in the comparative embodiment, when the valve is opened, the pressure on the upstream side of the injection hole 13 is low particularly in a part on the axis Ax1 side. That is, in the comparative embodiment, a pressure loss occurs in the fuel that passes through the valve seat 14 and flows along the seal portion 31 and flows into the injection hole 13.

In the present embodiment, since the virtual surface VS1 extending the valve seat 14 to the recess 15 crosses the injection hole inner wall 133, the fuel flowing toward the injection hole 13 along the valve seat 14 collides with a part on the axis Ax1 side of the injection hole inner walls 133, flows to the outlet opening 132 side along the injection hole inner wall 133, and is injected, when the valve is opened

As described above, the present embodiment includes the valve body 10 and the needle 30.

The valve body 10 includes the fuel passage 100 through which fuel flows, the valve seat 14 formed on the inner wall 101 forming the fuel passage 100, the recess 15 recessed in the direction of the axis Ax1 on the downstream side of the valve seat 14, and the injection hole 13 connected the recess 15 and the outer wall 102.

The needle 30 has the seal portion 31 that is able to be separated from the valve seat 14 and come into contact with the valve seat 14. The needle 30 can be reciprocated inside the valve body 10, and the sack chamber 150 is provided between the seal portion 31 and the recess 15.

In the present embodiment, the seal portion 31 is formed in a curved shape protruding in the axial direction of the needle 30. Therefore, the volume of the sack chamber 150 can be reduced. Further, it is possible to suppress the occurrence of pressure loss due to bending loss or the like in the fuel that passes through the valve seat 14 and flows along the seal portion 31 and flows into the injection hole 13.

The opening of the injection hole 13 in the recess 15 is defined as the inlet opening 131, the straight line extending through the inlet opening 131 that is the opening of the injection hole 13 in the recess 15 and parallel to the axis Ax1 of the valve body 10 is defined as the virtual straight line VL, the intersection of the virtual straight line VL and the inlet opening 131 is defined as the inlet intersection Pi, the intersection of the virtual straight line VL and the seal portion 31 is defined as a needle intersection Pn, the distance between the inlet intersection Pi and the needle intersection Pn on the same virtual straight line VL is defined as the distance Dh, and the distance between the recess 15 and the seal portion 31 on the axis Ax1 of the valve body 10 is defined as the distance Ds. When the seal portion 31 is in contact with the valve seat 14, the distance Dh is larger than the distance Ds (Dh>Ds). Therefore, the volume of the sack chamber 150 can be reduced while suppressing the pressure loss due to the flow passage reduction on the upstream side of the injection hole 13. Thereby, the deterioration of the flow characteristics due to the pressure loss and the deterioration of the atomization characteristics due to the decrease in the flow velocity can be suppressed.

Further, by reducing the volume of the sack chamber 150, the residual fuel in the sack chamber 150 after fuel injection can be reduced. Therefore, fuel wetting on the outer wall 102 of the valve body 10 due to leakage of residual fuel from the injection hole 13 can be suppressed. Thereby, generation of the particulate material after fuel injection can be suppressed.

Further, in the present embodiment, as a secondary effect of reducing the volume of the sack chamber 150, the pressure increase in the sack chamber 150 at the time of valve opening becomes faster, so that the flow rate of fuel at the initial stage of injection is improved and an improvement in atomization can be expected.

In addition, the present embodiment includes the valve body 10, the needle 30, and the filter 25.

The filter 25 has a plurality of holes 251 through which fuel can pass, and can collect foreign materials larger than the holes 251 among foreign materials in the fuel flowing through the fuel passage.

In the present embodiment, the distance between the recess 15 and the seal portion 31 on the axis Ax1 of the valve body 10 is defined as the distance Ds, the maximum width of the hole 251 is defined as the distance Df. The distance Ds is larger than the distance Df (Ds>Df). That is, the size of the foreign material passing through the filter 25 is smaller than the distance Ds between the recess 15 and the seal portion 31. Therefore, it is possible to prevent foreign material from being interposed between the seal portion 31 and the recess 15 of the needle 30. Thereby, the valve closing defect by a foreign material being interposed between the needle 30 and the recessed 15 can be suppressed. Therefore, after the valve is closed, leakage of fuel from the injection hole 13 can be suppressed, and generation of particulate material can be suppressed.

In the present embodiment, the seal portion 31 is formed in a curved shape protruding in the axial direction of the needle 30. In the present embodiment, the seal portion 31 is formed in the spherical shape protruding in the axial direction of the needle 30. Therefore, the volume of the sack chamber 150 can be reduced. Further, it is possible to more effectively suppress the occurrence of pressure loss due to bending loss or the like in the fuel that passes through the valve seat 14 and flows along the seal portion 31 and flows into the injection hole 13. Further, the seal portion 31 can be easily and accurately formed by cutting or polishing.

Moreover, in the present embodiment, a virtual surface VS1 which extends the valve seat 14 to the recess 15 side crosses the injection hole inner wall 133 which is an inner wall of the injection hole 13. Therefore, when the valve is opened, the fuel flowing along the valve seat 14 toward the injection hole 13 collides with a portion on the axis Ax1 side of the injection hole inner wall 133, flows along the injection hole inner wall 133 toward the outlet opening 132, and is injected. Thereby, the fuel is turned into a liquid film and atomization is promoted.

In the present embodiment, the volume of the sack chamber 150 is smaller than 0.06 mm³ (cubic millimeter). Therefore, after the needle 30 is closed, the amount of fuel wetting, which is the amount of residual fuel in the sack chamber 150 that leaks from the injection hole 13 and adheres to the outer wall 102 of the valve body 10, can be reduced. Thereby, the generation amount of particulate material such as soot can be further reduced.

### Second Embodiment

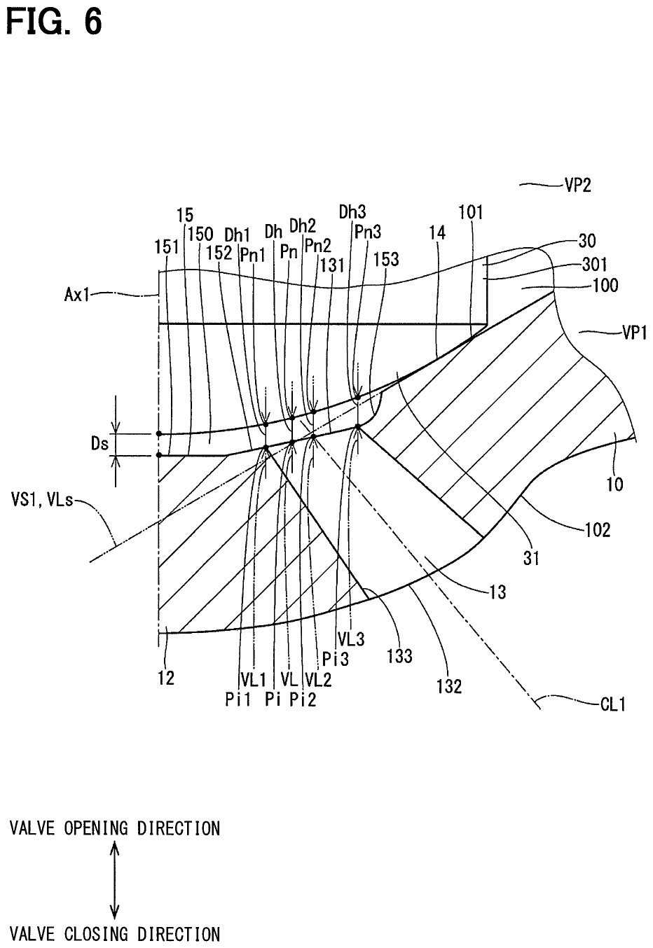

A part of the fuel injection valve according to the second embodiment is shown in FIG. 6. In the second embodiment, the configuration of the injection holes 13 is different from that in the first embodiment.

In the second embodiment, the injection hole inner wall 133 of the injection hole 13 is formed in a tapered shape so as to be separated from the injection hole center line CL1 as it goes from the inlet opening 131 side to the outlet opening 132 side. Therefore, when the fuel is injected from the injection hole 13, the liquid film formation of the fuel is further promoted, and further atomization of the fuel can be expected.

Other than the points described above, the configuration of the second embodiment is similar to that of the first embodiment.

### Third Embodiment

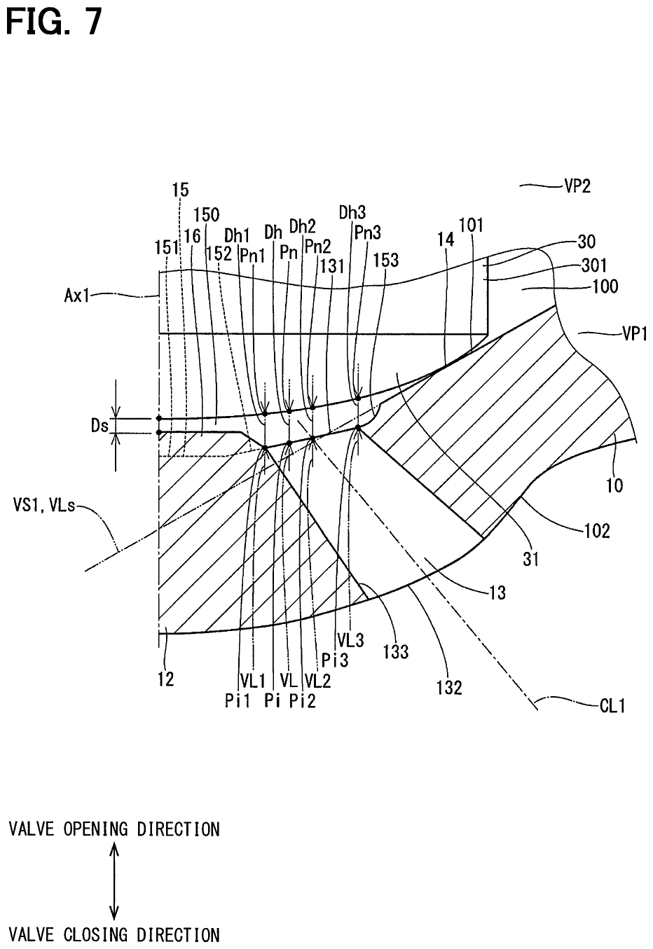

A part of the fuel injection valve according to the third embodiment is shown in FIG. 7. In the third embodiment, the configuration of the valve body 10 and the needle 30 is different from that of the second embodiment. In the third embodiment, the valve body 10 further includes a convex 16.

The convex 16 is formed so as to protrude in a circular shape from the recess 15 to the seal portion 31 side on the axis Ax1 side of the plurality of inlet openings 131. More specifically, the convex 16 is formed so as to protrude from the flat portion 151 of the recess 15 and an inner edge part of the tapered portion 152 to the seal portion 31 side. Therefore, the volume of the sack chamber 150 can be reduced.

In the third embodiment, as in the first and second embodiments, the seal portion 31 is formed into a curved surface and a spherical surface that protrudes in the axial direction of the needle 30. However, in the third embodiment, the curvature of the wall surface of the seal portion 31 changes as it goes outward in the radial direction of the needle 30 in the cross section along the virtual plane VP2 including the axis of the needle 30.

In the third embodiment, the distance Dh1 is larger than the distance Dh2, and the distance Dh2 is larger than the distance Dh3 (Dh1>Dh2>Dh3).

The third embodiment has a configuration similar to the configuration of the second embodiment except the point described above.

In the third embodiment, the distance Dh is also larger than the distance Ds, and the distance Ds is also larger than the distance Df (Dh>Ds and Ds>Df). Therefore, fuel pressure loss between the valve seat 14 and the injection hole 13 can be suppressed, and generation of particulate material after fuel injection can be suppressed.

### Other Embodiments

In other embodiment of the present disclosure, the foreign material collecting portion may be formed of any material such as a mesh filter or a porous material as long as it has a hole through which fuel can pass. Moreover, the foreign material collection portion may be formed such that the distance Ds is equal to or less than the distance Df. Moreover, in other embodiment of the present disclosure, the fuel injection valve does not need to include the foreign material collection portion. In this case, it is desirable to remove foreign materials in the fuel on the upstream side of the fuel injection valve.

In other embodiment of the present disclosure, the distance Dh may be equal or less than the distance Ds. In this case, it is desirable that the fuel injection valve includes a foreign material collecting portion and the distance Ds is larger than the distance Df (Ds>Df).

In other embodiments of the present disclosure, the relationship between the distance Dh1, the distance Dh2, and the distance Dh3 may be set in any manner.

Moreover, in the above-mentioned embodiment, the seal portion 31 is formed in the curved surface shape and spherical shape which protrudes in the axial direction of the needle 30. On the other hand, in other embodiment of the present disclosure, the seal portion 31 may be formed in an aspherical curved surface shape, a planar shape, or a tapered shape that approaches the axis of the needle 30 as it goes in the valve closing direction. Furthermore, the seal portion 31 may have a protrusion that protrudes toward the recess 15. In these cases, it is desirable that the fuel injection valve includes a foreign material collecting portion and the distance Ds is larger than the distance Df (Ds>Df). Further, in other embodiment of the present disclosure, the virtual surface VS1 obtained by extending the valve seat 14 toward the recess 15 does not have to cross the injection hole inner wall 133.

In other embodiment of the present disclosure, the volume of the sack chamber 150 may be set to any size as long as it is smaller than 0.06 mm³ (cubic millimeter). However, if the volume of the sack chamber 150 is too small, the pressure loss on the upstream side of the injection hole 13 may increase. Therefore, it is desirable that the volume of the sack chamber 150 is set to a predetermined value or more and smaller than 0.06 mm³ (cubic millimeter).

In other embodiment of the present disclosure, the volume of the sack chamber 150 may be set to 0.06 mm³ (cubic millimeter) or more.

In other embodiment of the present disclosure, the number of injection holes 13 is not limited to six, and any number of injection holes 13 may be formed in the valve body 10.

In other embodiment of the present disclosure, the recess 15 may not have one of the flat portion 151 or the tapered portion 152.

Moreover, in other embodiment of the present disclosure, the cylindrical portion 11 and the bottom portion 12 of the valve body 10 may be formed separately. Moreover, in other embodiment of the present disclosure, the first cylinder part 21 of the housing 20 and the cylindrical portion 11 of the valve body 10 may be integrally formed. Moreover, in other embodiment of the present disclosure, the third cylinder part 23, the fixed core 51, and the inlet part 24 may be formed in the different body.

In other embodiments of the present disclosure, the first cylinder part 21, the second cylinder part 22, and the third cylinder part 23 of the housing 20 may be integrally formed. In this case, for example, the second cylinder part 22 may be formed thin so as to be a magnetoresistance part.

Moreover, in the above-mentioned embodiment, the injection valve is applied to a direct injection type gasoline engine. On the other hand, in other embodiment of the present disclosure, the fuel injection valve may be applied to, for example, a diesel engine or a port injection type gasoline engine.

Thus, the present disclosure is not limited to the above embodiments but can be implemented in various forms without departing from the scope thereof.

The present disclosure has been described based on the embodiments. However, the present disclosure is not limited to the embodiments and structures. This disclosure also encompasses various modifications and variations within the scope of equivalents. Furthermore, various combination and formation, and other combination and formation including one, more than one or less than one element may be made in the present disclosure.

In an assumable example, a fuel injection valve in which a volume of a sack chamber formed between a needle and a valve body and connected to an injection hole is reduced is known. For example, in the fuel injection valve, the volume of the sack chamber is reduced so that a residual fuel in the sack chamber after fuel injection is reduced. Thereby, suppression of particulate material such as soot generated by combustion of residual fuel leaked from the injection hole is achieved.

In the fuel injection valve of the assumable example, a seal portion capable of contacting the valve seat is formed at one end of the needle. The seal portion is formed in a substantially planar shape. Here, a protrusion protruding into the sack chamber is formed at a center of the seal portion. Thereby, the volume of the sack chamber is reduced. However, since the protrusion is formed in the planar seal portion, the fuel that passes through the valve seat and flows along the seal portion collides with an outer peripheral wall of the protrusion and bends, and then flows into the injection hole. Therefore, pressure loss due to bending loss or the like occurs, and atomization of fuel injected from the injection hole may be impaired.

Moreover, in the above mentioned fuel injection valve, since the protrusion is formed in the center of the seal portion, a distance between the protrusion and an inner wall of the valve body is short. Therefore, there is a possibility that foreign material in the fuel is caught between the protrusion and the inner wall of the valve body. If foreign material is interposed between the protrusion and the inner wall of the valve body, there is a risk that a valve closing failure may occur. As a result, there is a possibility that fuel leaks from the injection hole after the valve is closed, and the particulate material increases.

The objective of the present disclosure provides the fuel injection valve which can suppress generation of the particulate material after fuel injection, without causing the increased pressure loss of fuel.

A first aspect of the fuel injection valve according to the present disclosure includes a valve body and a needle.

The valve body has a fuel passage through which fuel flows, a valve seat formed on the inner wall forming the fuel passage, a concave portion recessed in the axial direction on the downstream side of the valve seat, and an injection hole connecting the concave portion and the outer wall.

The needle has a seal portion that is separated from the valve seat and come into contact with the valve seat. The needle is reciprocated inside the valve body, and the sack chamber is provided between the seal portion and the recess.

In the present disclosure, the seal portion is formed in a curved shape protruding in an axial direction of the needle. Therefore, the volume of the sack chamber can be reduced. Further, it is possible to suppress the occurrence of pressure loss due to bending loss or the like in the fuel that passes through the valve seat and flows along the seal portion and flows into the injection hole.

An opening of the injection hole in the recess is defined as an inlet opening, a straight line extending through the inlet opening and being parallel to an axis of the valve body is defined as a virtual straight line, an intersection of the virtual straight line and the inlet opening is defined as an inlet intersection, an intersection of the virtual straight line and the seal portion is defined as a needle intersection, a distance between the inlet intersection and the needle intersection on the same virtual straight line is defined as a distance Dh, and a distance between the recess and the seal portion on the axis of the valve body is defined as a distance Ds. The distance Dh is larger than the distance Ds, when the seal portion is in contact with the valve seat. Therefore, the volume of the sack chamber can be reduced while suppressing the pressure loss due to the flow passage reduction on the upstream side of the injection hole. Thereby, the deterioration of the flow characteristics due to the pressure loss and the deterioration of the atomization characteristics due to the decrease in the flow velocity can be suppressed.

Further, by reducing the volume of the sack chamber, the residual fuel in the sack chamber after fuel injection can be reduced. Therefore, fuel wetting on the outer wall of the valve body due to leakage of residual fuel from the injection hole can be suppressed. Thereby, generation of the particulate material after fuel injection can be suppressed.

A second aspect of the fuel injection valve according to the present disclosure includes a valve body, a needle, and a foreign material collecting portion.

The valve body includes the fuel passage through which fuel flows, the valve seat formed on the inner wall forming the fuel passage, the recess recessed in the direction of the axis on the downstream side of the valve seat, and the injection hole connected the recess and the outer wall.

The needle has the seal portion that is able to be separated from the valve seat and come into contact with the valve seat. The needle can be reciprocated inside the valve body, and the sack chamber is provided between the seal portion and the recess.

The foreign material collecting portion has a plurality of holes through which fuel passes, and can collect foreign materials larger than the holes among foreign materials in the fuel flowing through the fuel passage.

In the present aspect, when the distance between the recess and the seal portion on the axis of the valve body is defined as the distance Ds, the maximum width of the hole is defined as the distance Df, the distance Ds is larger than the distance Df (Ds>Df). That is, the size of the foreign materials passing through the foreign material collecting portion is smaller than the distance Ds between the recess and the seal portion. Therefore, it is possible to prevent foreign material from being interposed between the seal portion and the recess of the needle. Thereby, the valve closing defect by the foreign material being interposed between the needle and the recessed can be suppressed. Therefore, after the valve is closed, leakage of fuel from the injection hole can be suppressed, and generation of particulate material can be suppressed.

1. A fuel injection valve comprising:
a valve body including a fuel passage through which fuel flows, a valve seat formed in an inner wall forming the fuel passage, a recess recessed in the axial direction on a downstream side of the valve seat, and an injection hole connecting the recess and an outer wall;
a needle including a seal portion that is separated from the valve seat and is in contact with the valve seat, the needle being configured to be reciprocally movable inside the valve body, and configured to form a sack chamber between the seal portion and the recess; and
a foreign material collecting portion having a plurality of holes through which fuel passes, and the foreign material collecting portion being configured to collect foreign materials larger than the holes among foreign materials in the fuel flowing through the fuel passage, wherein
the seal portion is formed in a curved shape protruding in the axial direction of the needle,
when an opening of the injection hole in the recess is defined as an inlet opening, a straight line extending through the inlet opening and being parallel to an axis of the valve body is defined as a virtual straight line, an intersection of the virtual straight line and the inlet opening is defined as an inlet intersection, an intersection of the virtual straight line and the seal portion is defined as a needle intersection, a distance between the inlet intersection and the needle intersection on the same virtual straight line is defined as a distance Dh, and a distance between the recess and the seal portion on the axis of the valve body is defined as a distance Ds,
the distance Dh is larger than the distance Ds, when the seal portion is in contact with the valve seat, and
when a maximum width of the holes is defined as a distance Df,
the distance Ds is larger than the distance Df.

2. A fuel injection valve comprising:
a valve body including a fuel passage through which fuel flows, a valve seat formed in an inner wall forming the fuel passage, a recess recessed in the axial direction on a downstream side of the valve seat, and an injection hole connecting the recess and an outer wall;
a needle including a seal portion that is separated from the valve seat and is in contact with the valve seat, the needle being configured to be reciprocally movable inside the valve body, and configured to form a sack chamber between the seal portion and the recess; and
a foreign material collecting portion having a plurality of holes through which fuel passes, and the foreign material collecting portion being configured to collect foreign materials larger than the holes among foreign materials in the fuel flowing through the fuel passage; wherein
when a distance between the recess and the seal portion on the axis of the valve body is defined as a distance Ds, and a maximum width of the holes is defined as a distance Df,
the distance Ds is larger than the distance Df, and
an inner diameter of an inlet opening that is an opening of the injection hole in the recess is larger than the distance Ds.

3. The fuel injection valve according to claim 2, wherein
the seal portion is formed in a curved shape protruding in an axial direction of the needle.

4. The fuel injection valve according to claim 1, wherein
the seal portion is formed in a spherical shape protruding in an axial direction of the needle.

5. The fuel injection valve according to claim 1, wherein
a virtual surface obtained by extending the valve seat toward the recess crosses an inner wall of the injection hole.

6. The fuel injection valve according to claim 1, wherein
a volume of the sack chamber is smaller than 0.06 mm³ (cubic millimeter).

7. The fuel injection valve according to claim 1, wherein
the valve body includes a convex configured to protrude from the recess to the seal portion side on the axis side of the valve body with respect to an inlet opening.

8. The fuel injection valve according to claim 2, wherein
the seal portion is formed in a spherical shape protruding in an axial direction of the needle.

9. The fuel injection valve according to claim 2, wherein
a virtual surface obtained by extending the valve seat toward the recess crosses an inner wall of the injection hole.

10. The fuel injection valve according to claim 2, wherein
a volume of the sack chamber is smaller than 0.06 mm³ (cubic millimeter).

11. The fuel injection valve according to claim 2, wherein
the valve body includes a convex configured to protrude from the recess to the seal portion side on the axis side of the valve body with respect to an inlet opening.
